(19) United States
(12) Patent Application Publication
(10) Pub. No.: US 2017/0238584 A1
(43) Pub. Date: Aug. 24, 2017

(54) OZONE-ACID BED FLUIDIZING DISINFECTION METHODS, DEVICES, AND SYSTEMS

(71) Applicant: Brian Kellerman, (US)

(72) Inventor: Brian Kellerman, Bexley, OH (US)

(21) Appl. No.: 15/049,588

(22) Filed: Feb. 22, 2016

(51) Int. Cl. A23L 3/3445; A23L 3/16; A23L 3/3508; A23L 3/3409

(52) U.S. Cl. CPC A23L 3/3445; A23L 3/34095; A23L 3/165; A23L 3/3508; A23V 2002/00

(57) ABSTRACT

Devices, methods and systems for disinfecting dry goods are described herein. In an aspect, dry goods such as dry foods can be sprayed within a disinfection device by a gas and liquid mixture. The gas and liquid mixture may include a mild acid and an ozone gas fluidized using a fluidization element of the device. As a result, spraying the dry goods with the gas and liquid mixture, the microbial activity on the dry goods are reduced and disinfection is achieved. Furthermore, organic dry goods such as corn, garlic, onions, and other such food items can maintain its organic status using the described disinfection devices, methods, and systems.

### TECHNICAL FIELD

This application relates generally to devices, systems, and methods for reducing microbial contamination on organic dry goods or other such food items.

### BACKGROUND

Consumption of organic food items has grown in popularity over the years. Many food consumers have begun to consciously select particular foods for consumption based on their nutritional content, agricultural production methods, and overall effect on personal health. Accordingly, organic foods have grown in popularity due to the agricultural methods used to grow and process such food items. Furthermore, a food item must satisfy and maintain various production requirements in order to receive an official organic label. For instance, some organic crops are grown in safe soil, grown in separate environments from conventional or non-organic products, free of modification, free of synthetic pesticides, GMO-free, and grown without the use of petroleum-based and sewage sludge-based fertilizers.

Despite the care and effort exerted during the production process of organic foods to keep them fresh and naturally controlled, organic food molecules are susceptible to supporting the growth of bacteria, yeast, mold, and other such microbial species. To prevent or remedy such microbial activity, food items can be disinfected using various existing processes including irradiation and ethylene oxide gas disinfection methods. However, such processes are not consistent with the standards of producing an organic food product. As such, when an organic food item undergoes such disinfection process, the food often seizes to maintain its eligibility for classification as an organic food.

The process of irradiating food items includes treating the food with ionizing radiation emitting from a range of irradiation waves over the food such as X-rays, Cobalt 60, high energy electron beams, or Cesium 137. The ionization waves are strong enough to dislodge electrons from food molecules and atoms, thereby converting the dislodged particles to electrically charged particles known as ions. The process disinfects the food item by reducing the number of disease causing organisms via disrupting the molecular structure of the food item; however, the irradiation also destroys some nutrients and creates previously absent compounds such as unique radiolytic products (UKP).

Similarly, other methods to reduce or inactivate the microbial population (e.g., mold spores) of a dry food item have included exposing the food to a gas such as ethylene oxide gas (EtO) or propylene oxide. However, like food irradiation, gas sterilization presents its own problems such as mutagenicity or carcinogenicity of the treated food item. Thus, the current state of disinfecting or sanitizing dry food items or intermediate dry food items is ineffective and often detriments the foods at a cost of accomplishing a mediocre level of disinfection. As such, there is a need for new technologies, devices, apparatuses, systems, and methods to solve the issues described above.

### SUMMARY

The following presents a simplified summary of the disclosure in order to provide a basic understanding of sonic aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with reducing microbial contamination on goods such as food items (e.g., dry foods). In accordance with a non-limiting embodiment, in an aspect, a device is provided comprising a fluid bed element comprising a cylindrical chamber element, a nozzle element comprising a set of spray nozzles, and a channel element, wherein the chamber element houses the nozzle element at a base portion of the chamber element, wherein the chamber element is configured to capture an ozone gas via the channel element and house a first ingredient, wherein the nozzle element is configured to spray a first acid solution into the chamber element, wherein the first acid solution diffuses with the ozone gas within the chamber element forming a diffused mixture comprising the first acid solution combined with the first ozone gas, and the diffused mixture encapsulates exposed surfaces of the first ingredient; an ozone generator element connected to the fluid bed element via the channel element affixed to a connection port opening within a wall of the ozone generator element, wherein the ozone generator element produces the ozone gas that is captured by the cylindrical chamber element; and a gas distribution element that pumps the ozone gas from the ozone generator element to the cylindrical chamber element via the channel element.

In various aspects, the device further comprises an exhaust element comprising an opening at the top surface of the cylindrical chamber element, wherein the exhaust element is configured to vent out the diffused mixture from the cylindrical chamber element. In another aspect, the the ozone generator element is a corona ozone generator configured to discharge a gas fed into the ozone generator across a dielectric that generates an electric field.

The disclosure further discloses a non-limiting method comprising inputting a first ingredient into a chamber element of a fluidizing disinfection device, wherein the fluidizing disinfection device comprises a fluid bed element comprising the chamber element, and wherein the fluid bed element is connected to an ozone generator element via a channel element connected to a connection port element of the ozone generator element; heating air within a chamber element of the fluid bed element within a first temperature range; releasing an ozone gas into the chamber element via the connection port element; releasing a mist comprising a first acid into the chamber element using a nozzle element of the fluidizing disinfection device, wherein the first acid diffuses with the first ozone gas suspended in the chamber element, and wherein a diffused mixture comprising the first acid and the first ozone gas coats the first ingredient; and reducing a first microbial agent count of a diffused mixture coated first ingredient as compared to a second microbial agent count of the first ingredient absent a coating of the diffused mixture, wherein the first microbial agent count is less than the second microbial agent count.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting device for reducing microbial contamination on goods, wherein the device comprises but is not limited to a cylindrical chamber element, a channel element, a nozzle element, and a connection port.

FIG. 2 illustrates an example non-limiting device for reducing microbial contamination on goods, wherein the device comprises but is not limited to a cylindrical chamber element, a channel element, a nozzle element, a connection port, and an exhaust element.

FIG. 3 illustrates an example non-limiting method for reducing microbial contamination on goods.

FIG. 4 illustrates an example non-limiting system for reducing microbial contamination on goods.

FIG. 5 illustrates an example non-limiting system for reducing microbial contamination on goods.

FIG. 6 illustrates an example non-limiting system for reducing microbial contamination on goods.

FIG. 7 illustrates an example non-limiting system for reducing microbial contamination on goods.

FIG. 8 illustrates an example non-limiting system for reducing microbial contamination on goods.

FIG. 9 illustrates an example non-limiting system for reducing microbial contamination on goods.

FIG. 10 illustrates an example non-limiting system for reducing microbial contamination on goods.

### DETAILED DESCRIPTION

### Overview

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

By way of introduction, the subject matter disclosed in this disclosure provides devices, systems, and methods for reducing microbial contamination on organic dry goods or other such food items (e.g., moist goods, intermediate dry goods, etc.). The disclosed device and method facilitate the disinfection of food items including dry foods while maintaining the nutritional integrity of the item. Food items such as organic foods guarantee how an agricultural product was grown and handled before it reached the consumer. The device and methods disclosed herein can assist processed organic foods to maintain its organic status by ensuring the good meets a consistent standard even during the disinfection process.

To maintain such standard of food quality (e.g., according to requirements set out via the US Department of Agriculture's National Organic Program (NOP), etc.), the device and methods employ products, components, solvents, and standards consistent with organic standards to disinfect the dry foods. For instance, the disclosed devices and methods can make use of ozone gas, lactic acid, and citric acid, which are listed on the NOP's National List of Allowed and Prohibited Substances which identifies synthetic substances that may be used in relation to processing organically certified foods. The disinfection devices and methods make use of bed fluidization mechanics and introduction of ozone to the food items environment in order to perform disinfection that destroys microbial activity while preserving the good itself.

### Example Devices and Methods

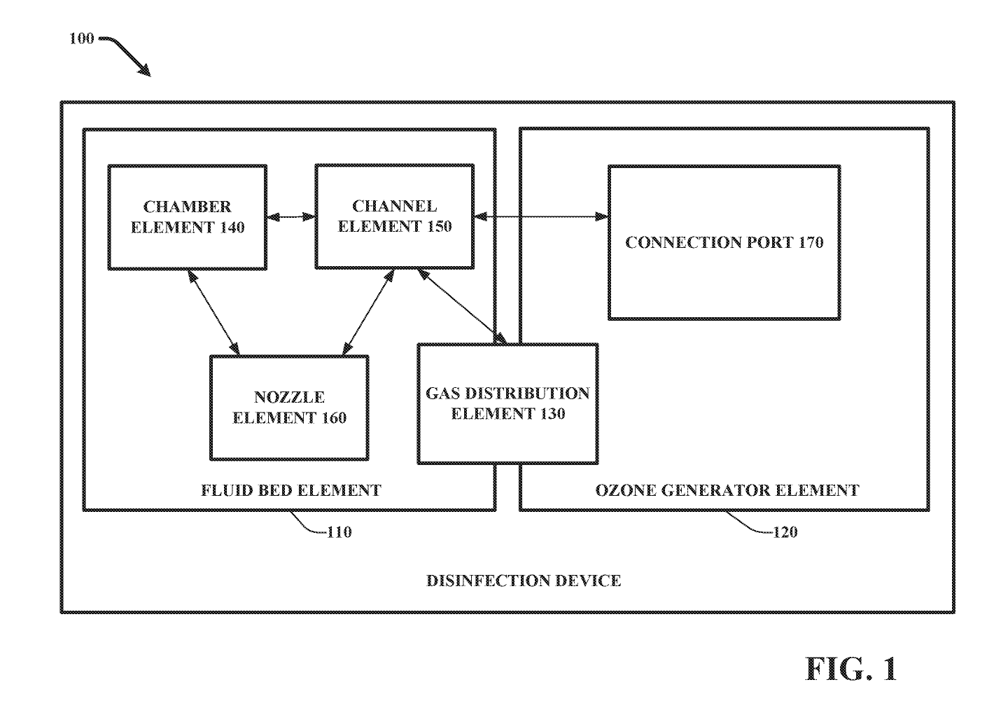

Turning now to the drawings, in which like numerals represent like (but not necessarily identical) elements throughout the figures, example embodiments of the disclosed subject matter are described. Turning to FIG. 1, illustrated is a device diagram depicting a non-limiting embodiment of a device 100 for disinfecting goods. As depicted in FIG. 1, a device 100 comprises a fluid bed element 110, an ozone generator 120 element, and a gas distribution element 130. In an aspect, the various components of device 100 are connected either directly or indirectly. For example, in a non-limiting embodiment, a cylindrical chamber element 140 can be connected to an ozone generator element 120 via a channel element 15 and a connection port 170.

In an embodiment, device 100 employs a fluid bed element 110 comprising a cylindrical chamber element 140, a nozzle element 160 comprising a set of spray nozzles, and a channel element, wherein the chamber element 140 houses the nozzle element 160. In an aspect, nozzle element 160 can be housed at a base portion of chamber element 140, wherein chamber element 140 is configured to capture an ozone gas via channel element 150, capture an acid at a second channel element, and house a first ingredient. In another aspect, nozzle element 160 is configured to spray a first acid solution into chamber element 140, wherein the first acid solution diffuses with the ozone gas within chamber element 140 forming a diffused mixture comprising the first acid solution combined with the first ozone gas, and the diffused mixture encapsulates exposed surfaces of the first ingredient.

In an aspect, device 100 employs fluid bed element 110 to facilitate the occurrence of a fluidized bed disinfection process. A fluidized bed is formed when a solid particulate substance (e.g., dry good such as dry foods) is placed under appropriate conditions (e.g., temperature and pressure conditions within chamber 140) to cause a mixture comprising ingredients of varying states to behave as a fluid (e.g., causing a gas and a liquid to behave as a fluid). In an aspect, fluid bed element 110 can facilitate a pressurized fluid comprising a corona ozone gas and an acid (e.g., acetic acid, lactic acid, citric acid, etc.) to coat the dry goods and accordingly disinfect the dry goods by reducing microbial activity on the dry good surfaces. The benefit of device 100 providing the capability of combining a corona ozone gas and an acid is the ability of the combined mixture to possess properties and characteristics of normal fluids such as the ability to free flow and coat the dry goods and the ability to be pumped as a pressurized aerosol in order to impact the dry goods at a specified force. This technique is referred to as fluidization and fluid bed element 110 facilitates implementation of this technique by device 100 and provides the benefits described above.

In an instance, a range of fluidized bed processing techniques can be implemented. For instance, a processing technique using an aerosolized suspension coating may be implemented, where the dry goods (e.g., dry food items) are suspended in an upward moving stream of air (e.g., ozone), liquid (e.g., acid), or both air and liquid (e.g., a mixture of ozone and acid). In an aspect, an air stream may be heated or cooled based on the best suitable conditions for the dry good being processed. In an aspect the sprayed mixture (e.g., liquid and gas) is emitted via one or more nozzle (e.g., using nozzle element 160) and the nozzle can be located at a range of positions within chamber element 140. For instance, an implementation of device 100 can include a top-spray (e.g., using top placed nozzles), a bottom spray (e.g., using nozzles positioned at the base of chamber 140), a spray that utilizes a fixed cylinder in the chamber to circulate the particles of food (in combination with a bottom spray, a top spray or both), and/or a rotor with side a spray mechanism.

In an aspect, embodiments of fluid bed element 110 comprising nozzle element 160 positioned at the base of chamber element 140 generate a shorter distance between a nozzle and bed of food thereby reducing premature drying of an applied coating using a gas and liquid mixture. Furthermore, in an aspect, chamber element 140 can comprise a cylinder shape or incorporate a cylinder within the chamber element 140. The cylindrical design facilities the circulation of dry goods or food particles within the gas and acid mixture which increases the efficacy of the disinfection technique. In another aspect, fluid bed element 110 may employ a continuous spraying operation (e.g., using nozzle element 160) or a batch spraying operation. In a non-limiting embodiment, the nozzle sprays are located at the bottom of a fluidized bed of dry goods.

Furthermore, in an aspect nozzle element 160, which employs nozzles or spray guns, can be used in connection with a distribution plate that directs the stream of gas/liquid mixture onto the dry goods. In an aspect, the nozzles associated with nozzle element 160 can be a single fluid (or pressure) nozzle, a two-fluid nozzle, or a rotary atomizer (e.g., spinning disc), or any combination of nozzle types. Furthermore, in an aspect, the nozzles of nozzle element 160 can be positioned within chamber element 140 such that the spray angle and spray direction can be varied and/or adjusted. Also, the flow rate of the gas and/or acid mixture released from any nozzle can be adjusted to satisfy spray pressure conditions, a gas and/or acid feed rate, as well as an airflow rate. In yet another aspect, the temperature within chamber element 140 can be adjusted and controlled.

In a non-limiting example embodiment, device 100 for disinfecting dry goods utilizes chamber element 140 to house the goods (e.g., via a base within chamber element 140). A base within chamber 140 can be used to rest the dry good or other goods upon. In a non-limiting embodiment, the dry goods can rest on the distribution plate itself In an aspect, within chamber 140 is nozzle element 160 that is connected to a second channel element leading to a source that disseminates a liquid (e.g., a mild acid). In yet another aspect, device 100 can employ ozone generator element 120 (e.g., a corona ozone generator) which generates an ozone gas that is pumped (e.g., using gas distribution element 130) into the fluid bed element 110 via channel element 150 that connects fluid bed element 110 to ozone generator element 120.

In an aspect, ozone generator element 120 can utilize a mechanism referred to as a corona discharge (e.g., a spark) to split a diatomic oxygen molecule into Valant oxygen atoms. The Valant oxygen atom (comprising a negative charge) quickly bonds with another oxygen atom and forms an ozone molecule. In an aspect, ozone generator element 120 can employ a power supply to produce an electrical discharge across a dielectric that splits oxygen molecules exposed (within an air gap) to the dielectric discharge into ozone. In another aspect, the power supply of the ozone generator element 120 can utilize a range of operating voltages and/or a range of operating frequencies.

Furthermore, in an aspect, a dielectric employed by ozone generator element 120 can utilize a range of materials such as glass, ceramic, mica, or quartz. In yet another aspect, ozone generator element 120 can employ a corona cell that facilitates the generation of ozone, wherein the corona cell is a tube of varying shapes (e.g., cylinder) or a flat plate. Also, the corona cell can be cooled using water cooling or air cooling to facilitate the creation of corona ozone gas. The ozone gas can also be generated using a source gas fed into ozone generation element 120; such gas feed can be oxygen or dry air.

In a non-limiting embodiment, ozone generator element 120 is connected to fluid bed element 110 via channel element 150. In various non-limiting embodiments, channel element 150 can connect to chamber element 140 at various locations, such as the base of chamber element 140 (e.g., side walls, top of the chamber, etc.). In another aspect, a second channel connects an element that houses acid to chamber element 140 and facilitates transportation of a dilute acid into chamber element 140 (e.g., using nozzle element 160). In another embodiment, channel element 150 can transport the dilute acid and the ozone into chamber element 140.

The dilute acid may be a citric acid, a lactic acid (used to disinfect organic foods), ascetic acid (used to disinfect non-organic foods), and other such acids. In an aspect, channel element 150 and the second channel can connect with chamber element 140 at a similar, same or different entry point. As such, channel element 150 and the second channel element may connect at the base of chamber element 140 and the dry goods sit on a base above both channels. Furthermore, in an aspect, the second channel can connect directly to nozzle element 160.

Thus in a non-limiting embodiment, the second channel via nozzle element 160 can spray a mist of dilute acid and ozone simultaneously, where ozone generator element 130 pumps (e.g. using gas distribution element 130) the ozone gas through channel element 150 an into chamber element 140. In an aspect, the acid and ozone can spray the dry food items within the chamber through the release of an aerosol action (e.g., comprising gas and acid) using spray heads of nozzle element 160. The aerosol spray will impact the dry goods with sufficient force to lift the dry goods (E.g., dry food particles) in a continuous action. The fluidized nature of fluid bed element 110 facilitates the continuous withdrawal of product and introduction of reactants (e.g., ozone gas and acid) into chamber element 140. Thus, the continuity of the process facilitated by device 100 eliminates the need for startup conditions (e.g., maintenance shut-downs, start and stopping of mixture spraying, stage-wise disinfection, etc.) that are common with batch processing.

As the dry good particles are lifted via the aerosolized spray, the ozone gas and acid mixture can better be able to react with the dry good surface areas on a particle level. As the gas and liquid mixture coat the dry good particles, the mixture acts as a microbial reduction agent thereby destroying microbial activity present on the dry good particles (e.g., food particles) without causing damage to the good itself. In another aspect, either the acid, ozone gas, or both can be sprayed out of the nozzle heads of nozzle element 160. Furthermore, in another aspect, ozone can be released into the chamber simultaneously with the release of the acid and such release can occur at the same or different entry points into chamber element 140 (e.g., release acid via nozzle 160 but ozone via a side wall of chamber 140).

In an aspect, a variety of dry goods can be processed and disinfected using device 100. Dry goods can include corn, wheat, garlic, onion, ginger, various fruits, dried herbs, spices, and various vegetable powders. Dry goods can also include organic dry goods in that device 100 performs disinfection using organically approved acids (in some instances) and in accordance with standards and requirements established for organic goods. In a non-limiting example method, device 100 can be used along the process chain from production to sale of dry goods. For instance, a dried good such as dried garlic can be inserted or input into chamber element 140. Device 100 can thereby implement a bed fluidizing disinfection process by employing the various elements and components of device 100. As such, device 100 can spray using nozzle element 160) the dried garlic, located within the cylinder of chamber element 140, with an acid (e.g., lactic acid, acetic acid, citric acid, or other such acids, etc.) and gas mixture. The mixture is pumped into the cylinder as a high pressure gas via nozzle element 160, where the mixture circulates the garlic for a range of time (e.g., 5 to 10 minutes), after which the gas is removed. The garlic is subsequently removed from the cylinder and can be sent for grinding, chopping, or other preparation mechanism in order to package the good for sale and shipment. Thus in an embodiment, device 100 can be utilized subsequent to the grinding of dry goods or prior to bagging or packaging the dry goods.

In another non-limiting embodiment, device 100 can be used to release ozone gas and acid into chamber element 140 absent a means of fluidization, such that the ozone gas and acid mixture are sprayed onto dry goods under high pressure conditions not derived from bed fluidization techniques. In another embodiment, various other disinfecting gasses aside from ozone can be utilized to disinfect the dry goods. Furthermore, in another non-limiting aspect, a range of other acids aside from citric acid, acetic acid, and lactic acid can be deployed into chamber element 140 to disinfect the dry goods as well. In yet another aspect, chamber element 140 can take a shape other than a cylinder, such as a cube, rectangular box, or other such geometric configurations that facilitate the circulation of gas and liquid mixture throughout the chamber,

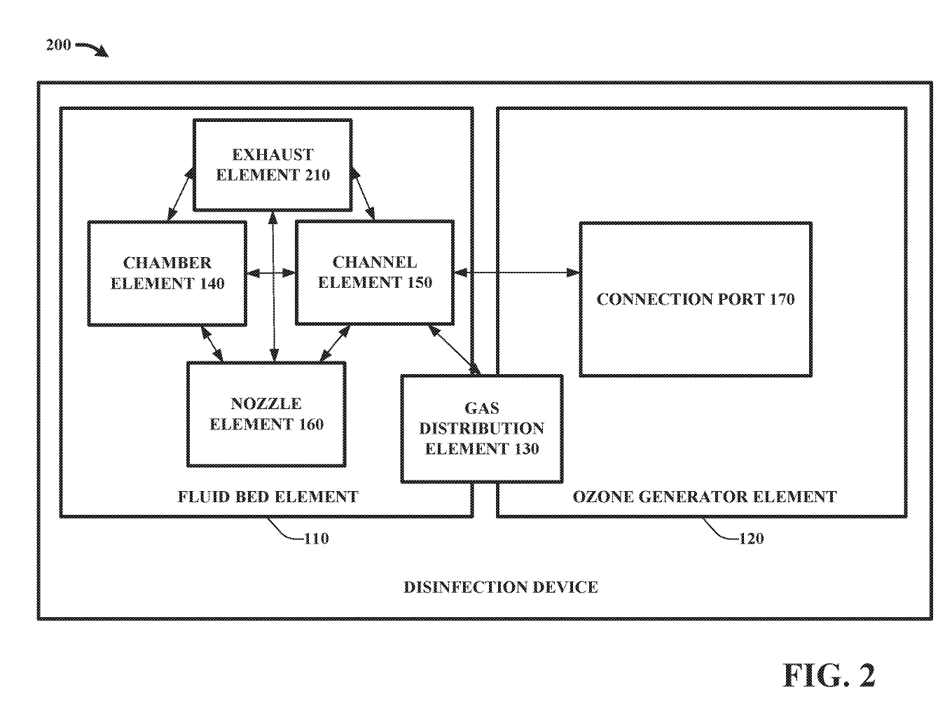

Turning now to FIG. 2, presented is another non-limiting embodiment of device 200 that facilitates disinfecting goods. In an aspect, device 200 can include same or similar structures, features, elements, and functionalities as device 100, Repetitive description of like elements employed in respective embodiments of devices described herein is omitted for sake of brevity. Device 200 can further employ an exhaust element 210 comprising an opening at the top surface of chamber element 140, wherein the exhaust element 210 is configured to vent out the diffused mixture from chamber element 140. In an aspect, exhaust element 210 can facilitate the escape or exit of the ozone and acid mixture from chamber element 140. Furthermore, in another aspect, chamber element 140 can facilitate the exit of any waste by product of the disinfection process as well. In an aspect, exhaust element 210 can exhausting a gas (e.g., ozone), acid, or mixture of gas and acid via an exhaust duct element attached to fluid bed element 110.

In a non-limiting embodiment device 100 and device 200 can employ an ozone generator element 120 that is a corona ozone generator configured to discharge a gas fed into the ozone generator across a dielectric that generates an electric field. In another non-limiting embodiment device 100 and device 200 can employ nozzle element is configured to spray the diffused mixture on the exposed surfaces of the first ingredient via an aerosol mist. In an aspect, the aerosol mist is released as a continuous spray that lifts the first ingredient, encapsulates the first ingredient in the mixture, preserves an original nutritional condition of the first ingredient prior to an application of the mixture and after the application of the mixture to the first ingredient, and eliminates a set of microbial agents present on the first ingredient prior to the application of the mixture.

In another non-limiting embodiment device 100 and device 200 can employ a connection port element that is a female threaded connection port located on ozone generator element 120. The connection port allows for a connection between ozone generator element 120 and fluid bed element 110. In another aspect, the acid used by device 100 and device 200 to disinfect the dry goods can include an ascetic acid solution that is comprised of a first percentage range of ascetic acid, wherein the citric acid solution is comprised of a second percentage range of citric acid, and wherein the lactic acid solution is comprised of a third percentage range of lactic acid. In a non-limiting embodiment, the percentage range of each respective acid can range between 0.25% and 15% percent acid in the acid solution.

In another aspect, the level of disinfection achieved using device 100 and device 200 can be quantified by a first microbial agent count is represented by a first total plate count, a first heterogeneous plate count, a first standard plate count or a first aerobic plate count, a first gram positive test, a first grain negative test, a first yeast colony or a first mold colony; and wherein the second microbial agent count is represented by a second total plate count, a second heterogeneous plate count, a second standard plate count or a second aerobic plate count, a second gram positive test, a second gram negative test, a second yeast colony, or a second mold colony, wherein the first microbial count and the second microbial count correspond to the first ingredient and the diffused mixture coated first ingredient respectively. Thus an ingredient processed and disinfected using device 100 and device 200 can present lower microbial agent counts, lower total plate counts, lower aerobic plate counts, and indicate the absence of mold and yeast as per grain negative tests as compared to the ingredient prior to being disinfected using device 100 and device 200. Furthermore, the dried good can be tested before disinfection using device 100 and after disinfection using device 200 for Escherichia Coli O157:H7, Salmonella Spp., Listeria Monocytogenes, Staphylococcus aureus, Bacillus cereus, Clostridium Botulinum, Hepatitis A, Norovirus, Rotavirus, Shigella, and other such microbial contaminants.

In an aspect, an experiment was conducted to demonstrate the efficacy of using ozone gas in combination with organic acids to reduce Aerobic Plate Count (APC), Yeast Count (YC), and Mold Counts (MC) in low moisture ingredients (e.g., corn, garlic, onion, etc.). The experiment employed an ozone generator, an ozone monitor, and an ozone destruction unit. The concentration of various acids used for disinfection is varied based on the varying levels of bacteria associated with respective dry goods. For instance, corn has a lower bacteria level at start as compared to garlic. Furthermore, based on the level of bacteria present on the dry good, a sufficiently low amount of acid is used to achieve the desired microbial reduction without souring the taste of the food item. The acids used included a first acid, which is not organically approved, a second acid which is organically approved and a third acid which is organically approved.

In an aspect, the experiment made use of an ozone generator Model TA 20, an ozone monitor, a Wurster Fluid Bed Unit Model 0002, corn cones, corn flour, garlic powder, onion powder, dehydrated apple pieces, potato flour, acetic acid 2% solution, acetic acid 1% solution, citric acid 2% solution, lactic acid 5% solution, safety masks, and sterile sample bags. The experiment made use of a Wurster Fluid Bed Unit Model 0002 assembled and connected to an Ozone Generator Model TA-20 via a ¼ inch thread connection port. Additionally, an ozone monitor was setup prior to the experiment. In an aspect, the Wurster fluid bed was heated up to a temperature where the air temperature was set between 45-55 degrees Celsius. The first sample was a 3-5 gram sample of corn that was evaluated and retained for sensory control purposes (e.g., for taste and smell comparisons). The sensory control sample tested as having which tested as having an Aerobic Plate Count Petrifilm (APCP) of 5,400 colony forming units (CFU) per gram (g), a Conform Count Petrifilm (CCP) of 560 CFU/g, a Mold Petrifilm Count (MPC) of 2,600 CFU/g, and a Yeast Petrifilm Count (YPC) of less than 10 CFU/g

In a first test, a sample of corn cones (e.g., dry food) weighing approximately 2 pounds was treated with a 1 percent solution of acetic acid and ozone for approximately 15 minutes. After completion of the process, 3-5 grams of the ozone and acid treated corn was evaluated for sensory properties against the control sample of corn. The remainder of the sample was collected in sterile bags for storage and testing. The results showed that the ozone mixture demonstrated an Aerobic Plate Count Petrifilm (APCP) of 150 colony forming units (CFU) per gram (g), a Coliform Count Petrifilm (CCP) of less than 10 CFU/g, a Mold Petrifilm Count (MPC) of 970 CFU/g, and a Yeast Petrifilm Count (YPC) of less than 10 CFU/g of the corn cone item after disinfection treatment using the device and the acid and ozone mixture as compared to the untreated corn cone sample prior to disinfection, which tested as having an APCP of 7,400 CFU, CCP of 1,200 CFU/g, MPC of 6,000 CFU/g, and a YPC of less than 10 CFU/g, wherein the respective counts were performed under testing techniques approved by the Association of Analytical Communities (AOAC).

In a second test, one sample of corn cone flour weighing approximately 2 pounds was placed in a fluid bed cylinder. The corn flour sample was treated with a 1% solution of acetic acid and ozone. The sample was evaluated and tested for sensory properties against the control sample.

In a third test, a 2-pound sample of garlic powder was treated with a 2% solution of acetic acid and ozone. The APCP after disinfection with the acetic acid and ozone mixture was 270,000 CFU/g, whereas prior to disinfection the APCP of the garlic powder was 240,000 CFU/g, CCP was less than 10 CFU/g, MPC was less than 10 CFU/g, and YPC was less than 10 CFU/g.

In a fourth test, a 1-pound sample of chopped onion was treated with a 2% solution of acetic acid and ozone. The APCP after disinfection with the acetic acid and ozone mixture was 4,100 CFU/g, MPC of 10 CFU/g, and a YPC of 80 CFU/g, as compared to an APCP of 16,000 CFU/g, CCP of less than 10 CFU/g, an MPC of 50 CFU/g, and a YPC of less than 10 CFU/g, wherein the respective counts were performed under testing techniques approved by the Association of Analytical Communities (AOAC).

In a fifth test a sample of corn cones weighing approximately 2 pounds was placed in a fluid bed cylinder. The corn cones were treated with a 2% solution of citric acid and ozone. The test results after disinfection were an ACPC of 180 CFU/g, a CCP of 10 CFU/g, a MPC of 710 CFU/g, and a YPC of less than 10 CFU/g as compared to the untreated sample which tested as having an APCP of 7,400 CFU, CCP of 1,200 CFU/g, MPC of 6,000 CFU/g, and a YPC of less than 10 CFU/g, wherein the respective counts were performed under testing techniques approved by the Association of Analytical Communities (AOAC).

In a sixth test, a 1-pound sample of chopped onion was treated with a 2% solution of citric acid and ozone. The sample was evaluated and tested for sensory properties against the control sample.

In a seventh test, a 2-pound sample of granulated garlic powder was treated with a 5% solution of lactic acid and ozone. The APCP after disinfection with the lactic acid and ozone mixture was greater than 1,800 CFU/g, the MPC was 20 CFU/g, and the YPC was 20 CFU/g, whereas prior to disinfection the APCP of of the garlic powder was 240,000 CFU/g, CCP was less than 10 CFU/g, MPC was less than 10 CFU/g, and YPC was less than 10 CFU/g.

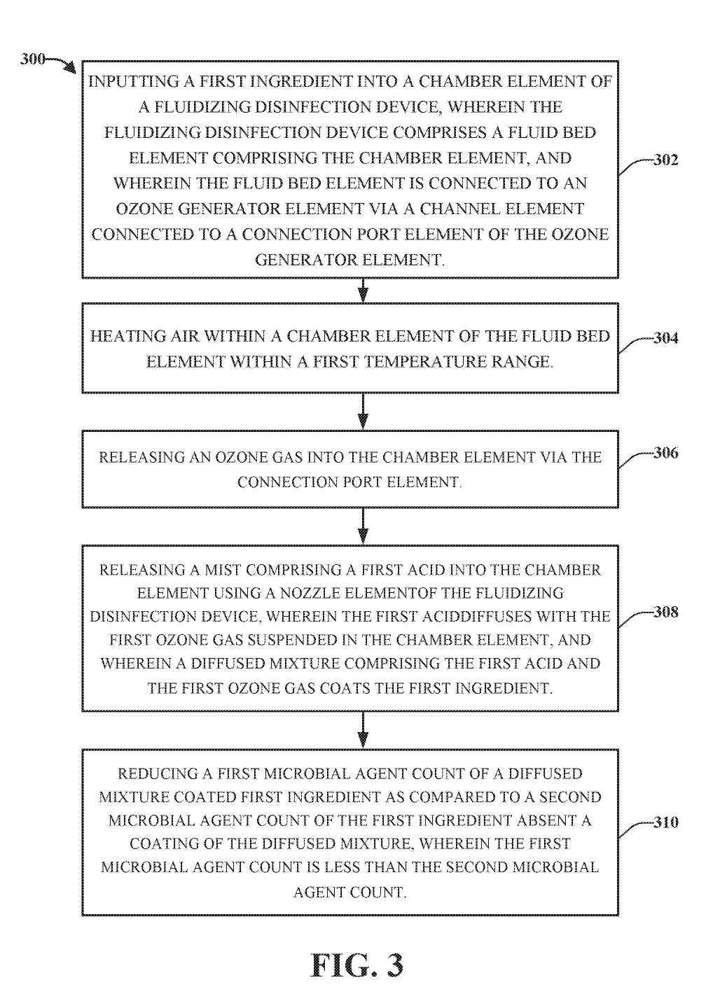

In view of the example systems and/or devices described herein, example methods that can be implemented in accordance with the disclosed subject matter can be further appreciated with reference to flowcharts in FIGS. 3-7. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein.

For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification.

FIG. 3 illustrates a flow chart of an example method 300 for disinfecting goods. At 302, a first ingredient is input into a chamber element (e.g., using chamber element 140) of a fluidizing disinfection device, wherein the fluidizing disinfection device comprises a fluid bed element (e.g., using fluid bed element 110) comprising the chamber element (e.g., using chamber element 140 and wherein the fluid bed element is connected to an ozone generator element (e.g., using ozone generator element 120) via a channel element connected to a connection port element of the ozone generator element. At 304, air within the chamber element of the fluid bed element is heated with a first temperature range. At 306, an ozone gas is released into the chamber element via the connection port element.

At 308, a mist comprising a first acid is released into the chamber element using a nozzle element of the fluidizing disinfection device, wherein the first acid diffuses with the first ozone gas suspended in the chamber element, and wherein a diffused mixture comprising the first acid and the first ozone gas coats the first ingredient. At 310, a first microbial agent count of a diffused mixture coated first ingredient is reduced compared to a second microbial agent count of the first ingredient absent a coating of the diffused mixture, wherein the first microbial agent count is less than the second microbial agent count.

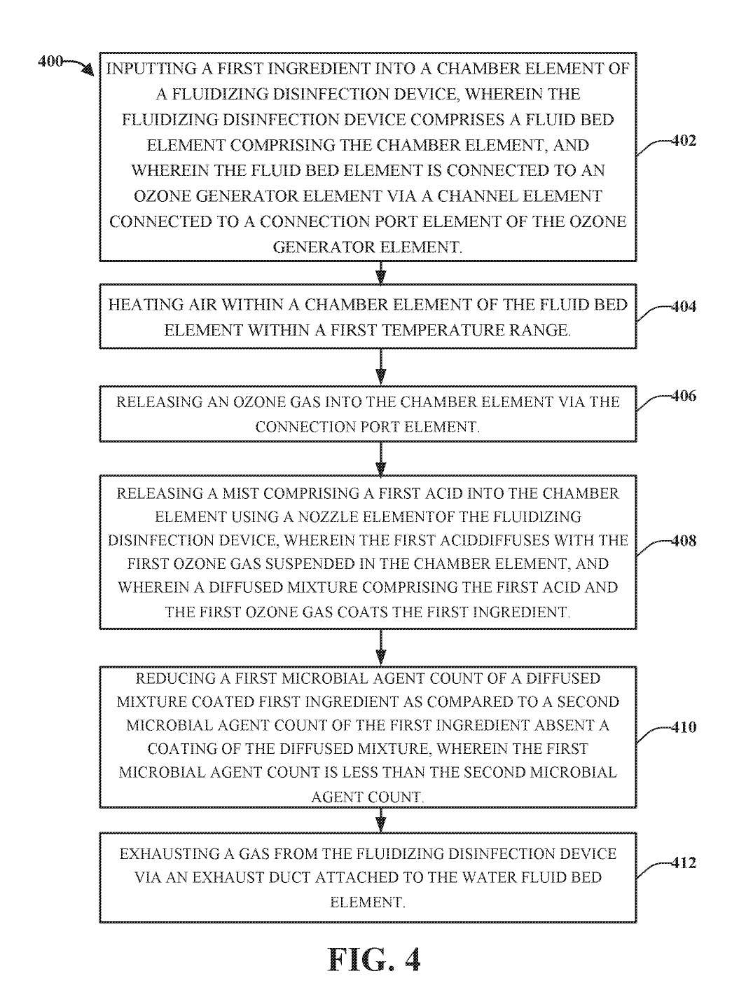

FIG. 4 illustrates a flow chart of an example method 400 for disinfecting goods. At 402, a first ingredient is input into a chamber element (e.g., using chamber element 140) of a fluidizing disinfection device, wherein the fluidizing disinfection device comprises a fluid bed element (e.g., using fluid bed element 110) comprising the chamber element e.g., using chamber element 140 and wherein the fluid bed element is connected to an ozone generator element (e.g., using ozone generator element 120) via a channel element connected to a connection port element of the ozone generator element. In an aspect, the first ingredient and the diffused mixture coated first ingredient is any one of a corn cone item, a corn flour item, a garlic powder item, a chopped onion item, a dried herb item, a dried spice item, a wheat item, a dried fruit item, or a dried vegetable item. At 404, air within the chamber element of the fluid bed element is heated with a first temperature range. In an aspect, the temperature range is between 30 degrees Celsius and 60 degrees Celsius. At 406, an ozone gas is released into the chamber element via the connection port element.

At 408, a mist comprising a first acid is released into the chamber element using a nozzle element of the fluidizing disinfection device, wherein the first acid diffuses with the first ozone gas suspended in the chamber element, and wherein a diffused mixture comprising the first acid and the first ozone gas coats the first ingredient. In an aspect, the chamber element is cylindrical in shape. At 410, a first microbial agent count of a diffused mixture coated first ingredient is reduced compared to a second microbial agent count of the first ingredient absent a coating of the diffused mixture, wherein the first microbial agent count is less than the second microbial agent count. At 412, a gas from the fluidizing disinfection device is exhausted via an exhaust duct attached to the water fluid bed element.

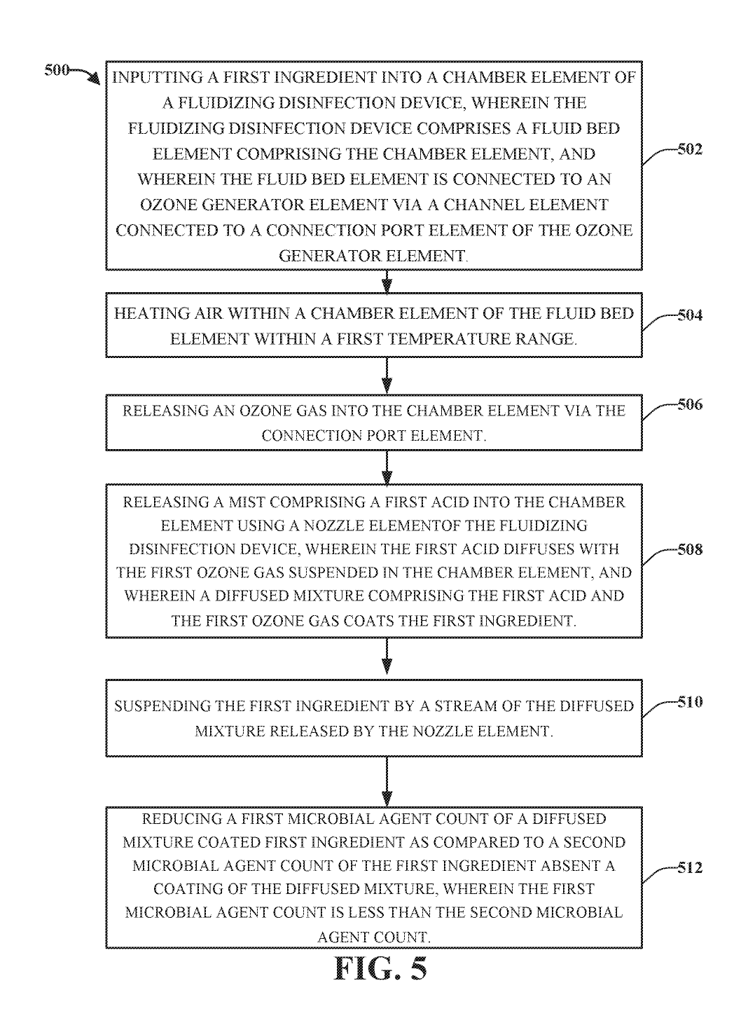

FIG. 5 illustrates a flow chart of an example method 500 for disinfecting goods. At 502, a first ingredient is input into a chamber element (e.g., using chamber element 140) of a fluidizing disinfection device, wherein the fluidizing disinfection device comprises a fluid bed element (e.g., using fluid bed element 110) comprising the chamber element (e.g., using chamber element 140 and wherein the fluid bed element is connected to an ozone generator element (e.g., using ozone generator element 120) via a channel element connected to a connection port element of the ozone generator element. At 504, air within the chamber element of the fluid bed element is heated with a first temperature range. At 506, an ozone gas is released into the chamber element via the connection port element.

At 508, a mist comprising a first acid is released into the chamber element using a nozzle element of the fluidizing disinfection device, wherein the first acid diffuses with the first ozone gas suspended in the chamber element, and wherein a diffused mixture comprising the first acid and the first ozone gas coats the first ingredient. In an aspect, the first acid is any one of an acetic acid solution, a citric acid solution, or a lactic acid solution. In another aspect, the ascetic acid solution is comprised of a first percentage range of ascetic acid, wherein the citric acid solution is comprised of a second percentage range of citric acid, and wherein the lactic acid solution is comprised of a third percentage range of lactic acid. At 510, the first ingredient is suspended by a stream of the diffused mixture released by the nozzle element. At 512, a first microbial agent count of a diffused mixture coated first ingredient is reduced compared to a second microbial agent count of the first ingredient absent a coating of the diffused mixture, wherein the first microbial agent count is less than the second microbial agent count.

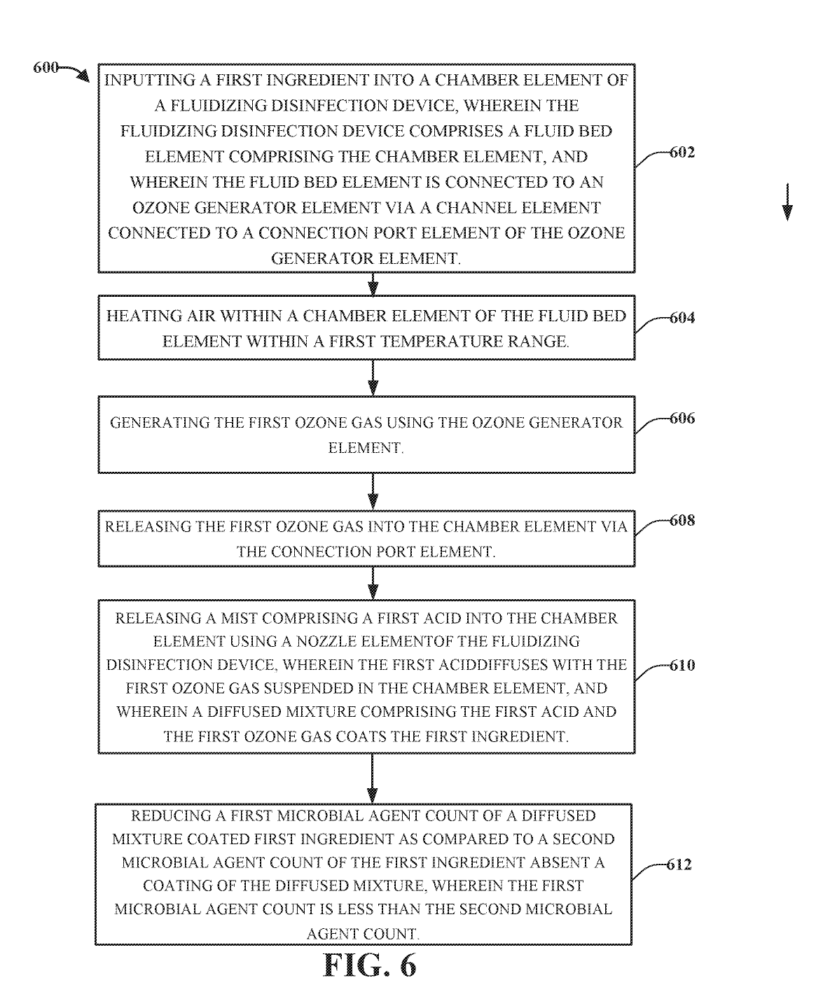

FIG. 6 illustrates a flow chart of an example method 600 for disinfecting goods. At 602, a first ingredient is input into a chamber element (e.g., using chamber element 140) of a fluidizing disinfection device, wherein the fluidizing disinfection device comprises a fluid bed element (e.g., using fluid bed element 110) comprising the chamber element (e.g., using chamber element 140 and wherein the fluid bed element is connected to an ozone generator element (e.g., using ozone generator element 120) via a channel element connected to a connection port element of the ozone generator element. At 604, air within the chamber element of the fluid bed element is heated with a first temperature range. At 606, the first ozone gas is generated using the ozone generator element. At 608, the first ozone gas is released into the chamber element via the connection port element,

At 610, a mist comprising a first acid is released into the chamber element using a nozzle element of the fluidizing disinfection device, wherein the first acid diffuses with the first ozone gas suspended in the chamber element, and wherein a diffused mixture comprising the first acid and the first ozone gas coats the first ingredient. At 612. a first microbial agent count of a diffused mixture coated first ingredient is reduced compared to a second microbial agent count of the first ingredient absent a coating of the diffused mixture, wherein the first microbial agent count is less than the second microbial agent count. In an aspect, the first microbial agent count is represented by a first total plate count, a first heterogeneous plate count, a first standard plate count or a first aerobic plate count, a first gram positive test, a first gram negative test, a first yeast colony or a first mold colony, and wherein the second microbial agent count is represented by a second total plate count, a second heterogeneous plate count, a second standard plate count or a second aerobic plate count, a second gram positive test, a second gram negative test, a second yeast colony, or a second mold colony, wherein the first microbial count and the second microbial count correspond to the first ingredient and the diffused mixture coated first ingredient respectively.

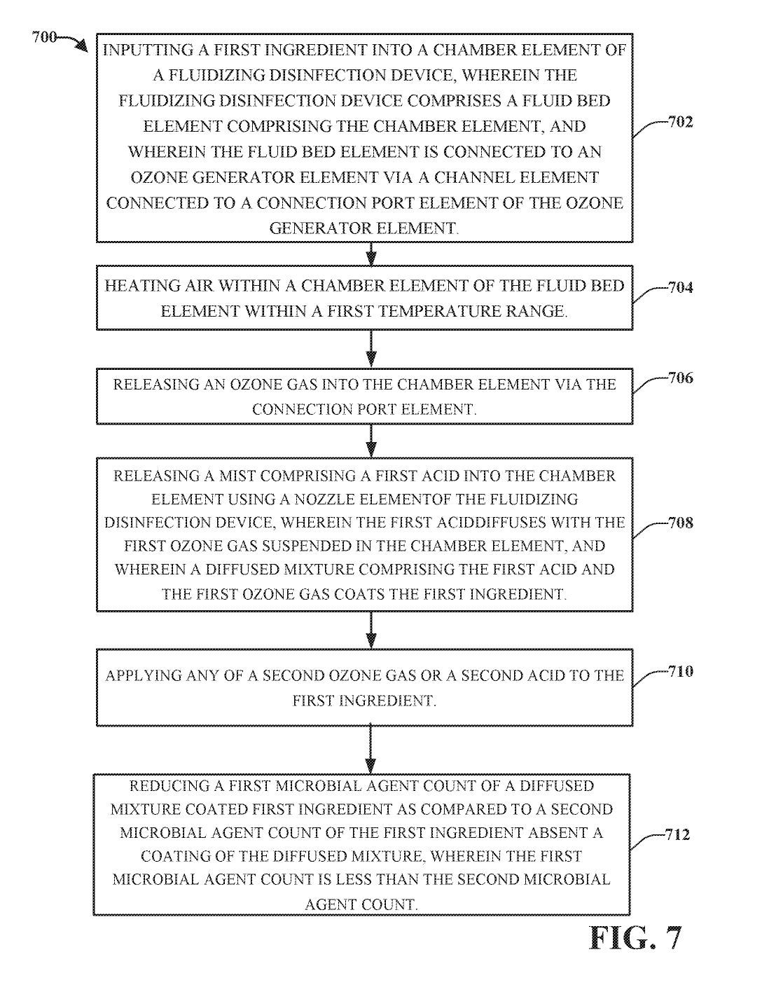

FIG. 7 illustrates a flow chart of an example method 700 for disinfecting goods. At 702, a first ingredient is input into a chamber element (e.g., using chamber element 140) of a fluidizing disinfection device, wherein the fluidizing disinfection device comprises a fluid bed element (e.g., using fluid bed element 110) comprising the chamber element (e.g., using chamber element 140 and wherein the fluid bed element is connected to an ozone generator element (e.g., using ozone generator element 120) via a channel element connected to a connection port element of the ozone generator element. At 704, air within the chamber element of the fluid bed element is heated with a first temperature range. At 706, an ozone gas is released into the chamber element via the connection port element. In an aspect, the connection port element is a female threaded connection port located on the ozone generator element.

At 708, a mist comprising a first acid is released into the chamber element using a nozzle element of the fluidizing disinfection device, wherein the first acid diffuses with the first ozone gas suspended in the chamber element, and wherein a diffused mixture comprising the first acid and the first ozone gas coats the first ingredient. At 710, any of a second ozone gas or a second acid is applied to the first ingredient. At 712, a first microbial agent count of a diffused mixture coated first ingredient is reduced compared to a second microbial agent count of the first ingredient absent a coating of the diffused mixture, wherein the first microbial agent count is less than the second microbial agent count.

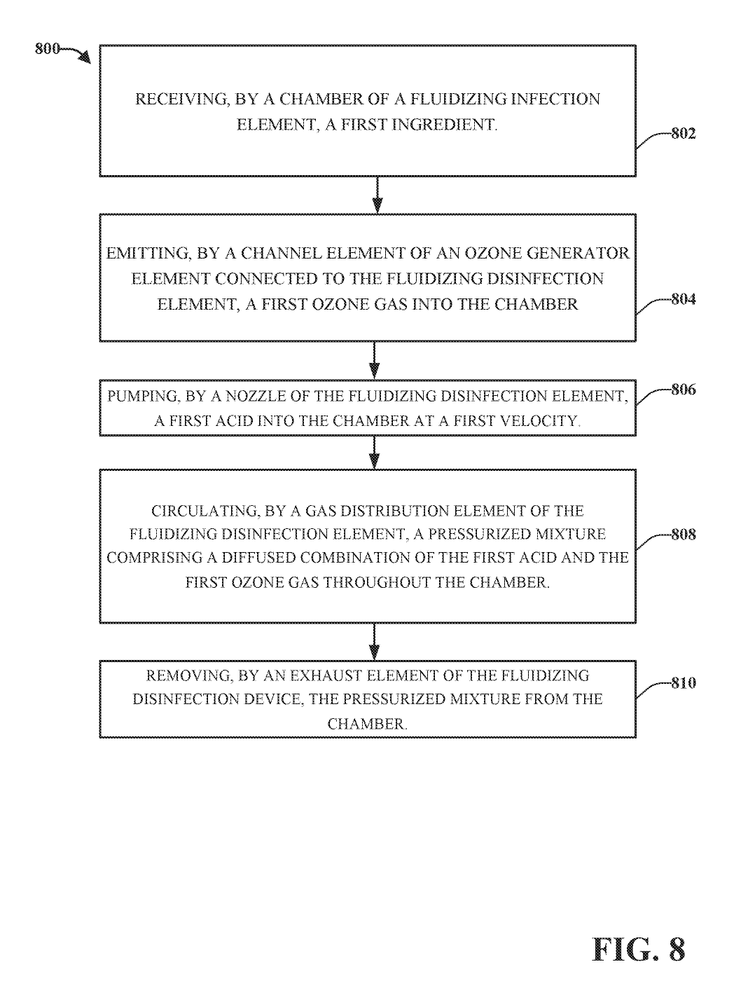

FIG. 8 illustrates a flow chart of an example method 800 for disinfecting goods. At 802, a chamber of a fluidizing disinfection element receives a first ingredient. At 804, a channel element of an ozone generator element connected to the fluidizing disinfection element emits a first ozone gas into the chamber. At 806, a nozzle of the fluidizing disinfection element pumps a first acid into the chamber at a first velocity. At 808, a gas distribution element of the fluidizing disinfection element circulates a pressurized mixture comprising a diffused combination of the first acid and the first ozone gas throughout the chamber. At 810, an exhaust element of the fluidizing disinfection device removes the pressurized mixture from the chamber.

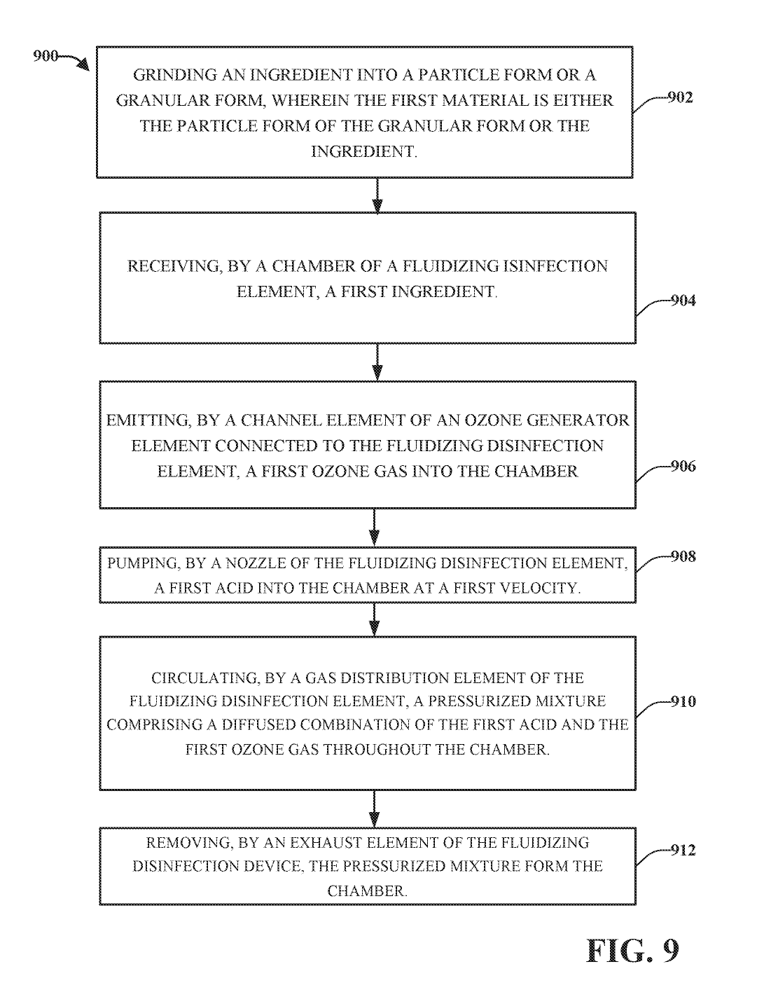

FIG. 9 illustrates a flow chart of an example method 900 for disinfecting goods. At 902, an ingredient is ground into a particle form or a granular form, wherein the first material is either the particle form or the granular form of the ingredient. At 904, a chamber of a fluidizing disinfection element receives a first ingredient. At 906, a channel element of an ozone generator element connected to the fluidizing disinfection element emits a first ozone gas into the chamber. At 908, a nozzle of the fluidizing disinfection element pumps a first acid into the chamber at a first velocity. At 910, a gas distribution element of the fluidizing disinfection element circulates a pressurized mixture comprising a diffused combination of the first acid and the first ozone gas throughout the chamber. At 912, an exhaust element of the fluidizing disinfection device removes the pressurized mixture from the chamber.

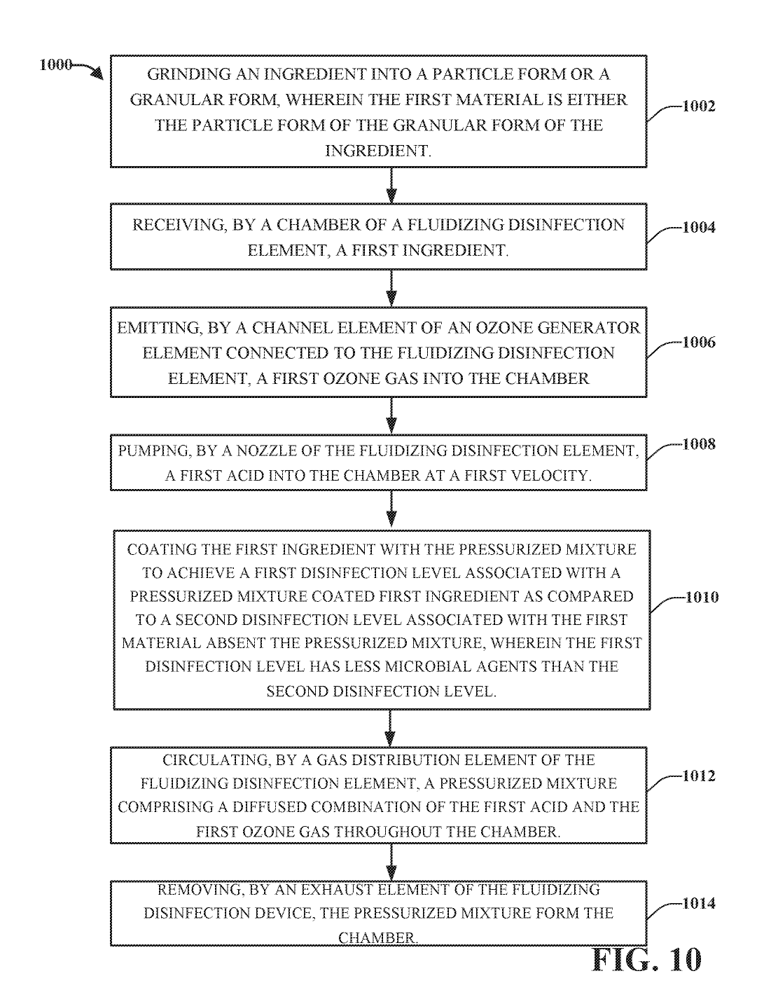

FIG. 10 illustrates a flow chart of an example method 1000 for disinfecting goods. At 1002, an ingredient is ground into a particle form or a granular form, wherein the first material is either the particle form or the granular form of the ingredient At 1004, a chamber of a fluidizing disinfection element receives a first ingredient. At 1006, a channel element of an ozone generator element connected to the fluidizing disinfection element emits a first ozone gas into the chamber. At 1008, a nozzle of the fluidizing disinfection element pumps a first acid into the chamber at a first velocity. At 1010. the first ingredient is coated with the pressurized mixture to achieve a first disinfection level associated with a pressurized mixture coated first ingredient as compared to a second disinfection level associated with the first material absent the pressurized mixture, wherein the first disinfection level has less microbial agents than the second disinfection level. At 1012, a gas distribution element of the fluidizing disinfection element circulates a pressurized mixture comprising a diffused combination of the first acid and the first ozone gas throughout the chamber. At 1014, an exhaust element of the fluidizing disinfection device removes the pressurized mixture from the chamber.

1. A method comprising:
inputting a first ingredient into a chamber element of a fluidizing disinfection device, wherein the fluidizing disinfection device comprises a fluid bed element comprising the chamber element, and wherein the fluid bed element is connected to an ozone generator element via a channel element connected to a connection port element of the ozone generator element;
heating air within the chamber element of the fluid bed element within a first temperature range;
releasing an ozone gas into the chamber element via the connection port element;
releasing a mist comprising a first acid into the chamber element using a nozzle element of the fluidizing disinfection device, wherein the first acid diffuses with the first ozone gas suspended in the chamber element, and wherein a diffused mixture comprising the first acid and the first ozone gas coats the first ingredient; and
reducing a first microbial agent count of a diffused mixture coated first ingredient as compared to a second microbial agent count of the first ingredient absent a coating of the diffused mixture, wherein the first microbial agent count is less than the second microbial agent count.

2. The method of claim 1, wherein the connection port element is a female threaded connection port located on the ozone generator element.

3. The method of claim 1, further comprising exhausting a gas from the fluidizing disinfection device via an exhaust duct element attached to the water fluid bed element.

4. The method of claim 1, wherein the chamber element is cylindrical in shape.

5. The method of claim 1, further comprising suspending the first ingredient by a stream of the diffused mixture released by the nozzle element.

6. The method of claim 1, further comprising generating the first ozone gas using the ozone generator element.

7. The method of claim 1, wherein the first ingredient and the diffused mixture coated first ingredient is any one of a corn cone item, a corn flour item, a garlic powder item, a chopped onion item, a dried herb item, a dried spice item, a wheat item, a dried fruit item, or a dried vegetable item.

8. The method of claim 1, wherein the first acid is any one of an acetic acid solution, a citric acid solution, or a lactic acid solution.

9. The method of claim 1, wherein the temperature range is between 30 degrees Celsius and 60 degrees Celsius.

10. The method of claim 8, wherein the ascetic acid solution is comprised of a first percentage range of ascetic acid, wherein the citric acid solution is comprised of a second percentage range of citric acid, and wherein the lactic acid solution is comprised of a third percentage range of lactic acid.

11. The method of claim 1, further comprising applying any of a second ozone gas or a second acid to the first ingredient.

12. The method of claim 1, wherein the first microbial agent count is represented by a first total plate count, a first heterogeneous plate count, a first standard plate count or a first aerobic plate count, a first gram positive test, a first gram negative test, a first yeast colony or a first mold colony, and wherein the second microbial agent count is represented by a second total plate count, a second heterogeneous plate count, a second standard plate count or a second aerobic plate count, a second gram positive test, a second gram negative test, a second yeast colony, or a second mold colony, wherein the first microbial count and the second microbial count correspond to the first ingredient and the diffused mixture coated first ingredient respectively.

13. A device comprising:
a fluid bed element comprising a cylindrical chamber element, a nozzle element comprising a set of spray nozzles, and a channel element, wherein the chamber element houses the nozzle element at a base portion of the chamber element, wherein the chamber element is configured to capture an ozone gas via the channel element and house a first ingredient, wherein the nozzle element is configured to spray a first acid solution into the chamber element, wherein the first acid solution diffuses with the ozone gas within the chamber element forming a diffused mixture comprising the first acid solution combined with the first ozone gas, and the diffused mixture encapsulates exposed surfaces of the first ingredient;
an ozone generator element connected to the fluid bed element via the channel element affixed to a connection port opening within a wall of the ozone generator element, wherein the ozone generator element produces the ozone gas that is captured by the cylindrical chamber element; and
a gas distribution element that pumps the ozone gas from the ozone generator element to the cylindrical chamber element via the channel element.

14. The device of claim 12, further comprising an exhaust element comprising an opening at the top surface of the cylindrical chamber element, wherein the exhaust element is configured to vent out the diffused mixture from the cylindrical chamber element.

15. The device of claim 12, wherein the ozone generator element is a corona ozone generator configured to discharge a gas fed into the ozone generator across a dielectric that generates an electric field.

16. The device of claim 14, wherein the nozzle element is configured to spray the diffused mixture on the exposed surfaces of the first ingredient via an aerosol mist.

17. The device of claim 15, wherein the aerosol mist is released as a continuous spray that lifts the first ingredient, encapsulates the first ingredient in the mixture, preserves an original nutritional condition of the first ingredient prior to an application of the mixture and after the application of the mixture to the first ingredient, and eliminates a set of microbial agents present on the first ingredient prior to the application of the mixture.

18. A method comprising:
receiving, by a chamber of a fluidizing disinfection element, a first ingredient;
emitting, by a channel element of an ozone generator element connected to the fluidizing disinfection element, a first ozone gas into the chamber;
pumping, by a nozzle of the fluidizing disinfection element, a first acid into the chamber at a first velocity;
circulating, by a gas distribution element of the fluidizing disinfection element, a pressurized mixture comprising a diffused combination of the first acid and the first ozone gas throughout the chamber; and
removing, by an exhaust element of the fluidizing disinfection device, the pressurized mixture from the chamber.

19. The method of claim 18, further comprising, grinding an ingredient into a particle form or a granular form, wherein the first material is either the particle form or the granular form of the ingredient.

20. The method of claim 18, further comprising, coating the first ingredient with the pressurized mixture to achieve a first disinfection level associated with a pressurized mixture coated first ingredient as compared to a second disinfection level associated with the first material absent the pressurized mixture, wherein the first disinfection level has less microbial agents than the second disinfection level.
